(19) United States
(12) Patent Application Publication
(10) Pub. No.: US 2015/0332730 A1
(43) Pub. Date: Nov. 19, 2015

(54) SYSTEM AND METHOD FOR REMOVING COMMERCIAL ADVERTISEMENT FROM RECORDED TV PROGRAMS

(71) Applicant: Sumit Bohra, Somerville, MA (US)

(72) Inventor: Sumit Bohra, Somerville, MA (US)

(21) Appl. No.: 14/279,422

(22) Filed: May 16, 2014

(51) Int. Cl. G11B 27/031; H04N 21/435; H04N 21/433; G11B 27/10; H04N 21/4147

(52) U.S. Cl. CPC G11B 27/031; G11B 27/10; H04N 21/4147; H04N 21/4334; H04N 21/435

(57) ABSTRACT

A system and method for removing commercials from recorded television programs. The system and method for removing commercials from recorded television programs is defined by a set top box containing instructions embodied in software stored on non-volatile memory which cause a processor in the set top box to identify breaks in television programming while recording, detect the presence of a commercial, flag detected commercials, and delete flagged commercials once recording ends. Conventional program metadata, such as closed captioning and program information metadata, is used by the set top box to detect, verify and flag commercials. The set top box can then playback the recorded television programs with the commercials having been deleted.

### BACKGROUND OF THE INVENTION

1. Field of the Invention

This invention relates generally to multimedia accessories and, more particularly, to a system and method for removing commercial advertisement from recorded television programming

2. Description of the Prior Art

The use of digital video recorders (DVR) to record and playback television and other multimedia programming is well known. Conventional DVRs are typically programmed or otherwise selected to record such programming, from a beginning time to an end time. With such audio/video programming, particularly television programming broadcasts (or television programs), the DVRs also record commercial advertisements (“commercials”) typically dispersed at various points within the television program. Consequently, a problem which still exists is that DVRs customarily record and playback such commercials along with the desired content in the same manner it was recorded. Thus, there remains a need for a system and method for removing commercials from recorded television programs which would automatically delete commercials from recorded content prior to availing it for playback. It would be helpful if such a system and method for removing commercials eliminated automatically detected commercials and marked them for deletion while recording. It would be additionally desirable for such a system and method for removing commercials to be integrated onto an apparatus which included conventional DVR capabilities.

The Applicant's invention described herein provides for a system and method adapted detect and remove commercials from recorded television programs. The primary steps in Applicant's system and method for removing commercials are identifying breaks in television programming while recording, detecting and flagging commercials, and deleting flagged commercials once recording ends. When in operation, the system and method for removing commercials enables a user to enjoy recorded television programming without having to watch or forward through commercials during playback. As a result, many of the limitations imposed by prior art structures are removed.

### SUMMARY OF THE INVENTION

A system and method for removing commercials from recorded television programs. The system and method for removing commercials from recorded television programs is defined by a set top box containing instructions embodied in software stored on non-volatile memory which cause a processor in the set top box to identify breaks in television programming while recording, detect the presence of a commercial, flag detected commercials, and delete flagged commercials once recording ends. Conventional program metadata, such as closed captioning and program information metadata, is used by the set top box to detect, verify and flag commercials. The set top box can then playback the recorded television programs with the commercials having been deleted.

It is an object of this invention to provide a system and method for removing commercials from recorded television programs which would automatically delete commercials from recorded content prior to availing it for playback.

It is another object of this invention to provide a system and method for removing commercials which eliminates automatically detected commercials and marks them for deletion while recording.

It is yet another object of this invention to provide a system and method for removing commercials integrated onto an apparatus which included conventional DVR capabilities.

These and other objects will be apparent to one of skill in the art.

### BRIEF DESCRIPTION OF THE DRAWINGS

FIG. 1 is a front perspective view of the set top box of a system for removing commercials from recorded television programs built in accordance with the present invention.

FIG. 2 is a front perspective view of the remote control of a system for removing commercials from recorded television programs built in accordance with the present invention.

FIG. 3 show the steps of a method for removing commercials from recorded television programs in accordance with the present invention.

### DETAILED DESCRIPTION OF THE INVENTION

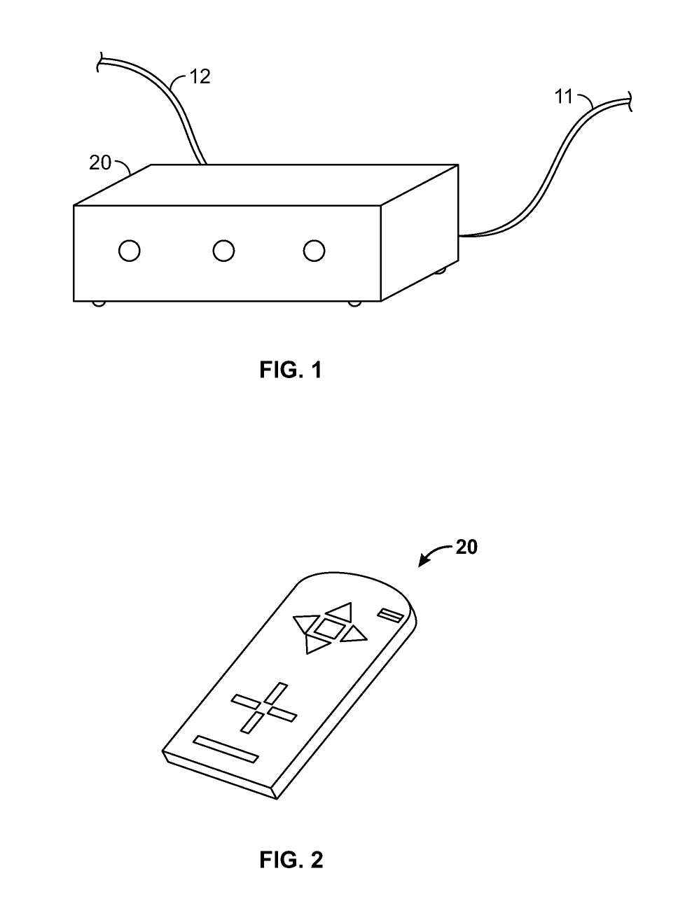

Referring now to the drawings and in particular FIGS. 1 and 2, a system for removing commercials from recorded television programs is shown having a set top box 10 and an accompanying remote control 20. The set top box 10 is configured as a conventional DVR set top box and configured to perform the method for removing commercials from recorded television programs through a series of instructions embodied in software stored on non-volatile memory within the set top box. In the preferred embodiment, the set top box 10 operates in conjunction with a subscription service box (not shown), such as a cable or satellite box (“cable box”), receiving electrical signals relating to television programs through a cable box wire 11 and transmitting electrical signals relating to television programs, either live from the cable box or recorded on the memory of the set top box 10, to a television or other display device (not shown) through a television wire 12. The set top box is used in conjunction with the cable box so that it can receive the formatted television signal as ready to be broadcast on a display device and not have to include the necessary codecs to format a signal from a service provider. As the set top box utilizes the metadata accompanying a selected television program to assist in identifying and flagging commercials, it needs to process a formatted (ready to be sent to a display device) television signal which has such metadata already unpacked from any compression and/or storage format and accessible in the same manner it would be to a display device such as a television set. It is contemplated, however, that the set top box 10 may be embodied in the same structure as the cable box, receiving a raw input signal from a television service provider and transmitting a formatted output signal to the television, provided the method described herein is performed after the input signal is formatted and ready to be displayed.

The remote control 20 is a conventional wireless remote control device and can transmit wireless signals to control the recording and playback operation of the set top box 10 in the same manner as conventional wireless remote controls.

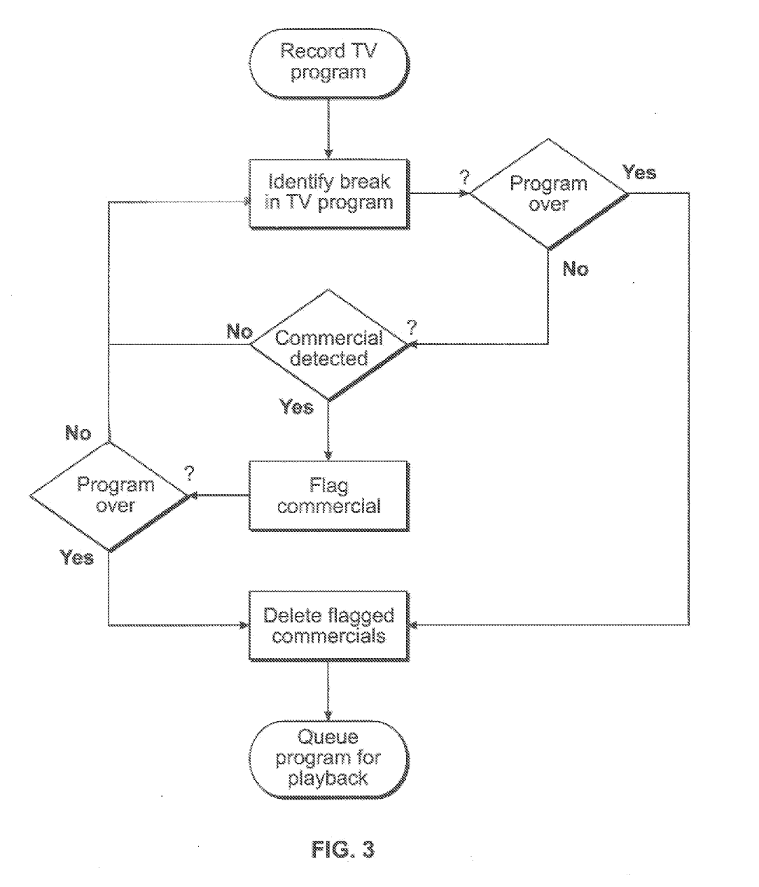

Referring now to FIG. 3, the method performed by a set top box built in accordance with the present invention to remove commercials from recorded television programs begins with a command to record a program. As the set top box is designed to be connected between the television and the cable box, and receive signals from the cable box before passing them along to the television, the set top box monitors the activity of the cable box, including when television programs are being recorded. The set top box is also configured to directly record a television program that is output for viewing by the cable box at the time it is output. When the cable box provides an output that it is recording one or more television programs, or when the set top box has been commanded to record the television program being output by the cable box, the set top box commences recording and while recording, monitors the program metadata being output with the broadcast signal, such as closed captioning metadata, in order to identify a break in the programming. It is contemplated that a break may be identified by the program metadata ceasing the inclusion of closed caption metadata when such metadata has been previously provided or by the metadata commencing the inclusion of closed caption metadata when such metadata has not been previously provided. The program metadata may also identify breaks in the television program directly, and such information would them be used directly by the set top box to identify the same.

Once a break has been identified, the set top box queries whether the program is over. The same program metadata analysis is performed to determine this as is performed to identify breaks. If the program is over, the all commercials previously flagged are deleted and the program is queued on the set top box for playback. If the program is not over, a query is run to confirm that a commercial is detected. The same program metadata analysis is performed to determine this as is performed to identify breaks. If no commercial is identified, the set top box simply continues recording. If a commercial is identified, the commercial is flagged, particularly its start time and end time, with the start time being the time of the identified break and the end time being the time the set top box determines the television program has recommenced. The same program metadata analysis is performed to determine the television program has recommenced as is performed to identify breaks.

After the commercial is flagged, the set top box again queries whether the program is over. If the program is over, the all commercials previously flagged are deleted and the program is queued on the set top box for playback. If the program is not over, the set to box recommences normal recording until another break is identified. It is contemplated that for sequential commercials, the set top box will continue recording while flagging each commercial, again deleting all flagged commercials once it determines the program is over and recording stops.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A method for removing commercials from recorded television programs, comprising the steps of:
providing an information appliance configured receive content signals relating to multimedia programming and transmit content signals relating to multimedia programming to an output apparatus;
recording by said information appliance multimedia programming in content signals received;
identifying by said information appliance commercial advertising content interspersed in the multimedia programming being recorded in real time;
flagging by said information appliance commercial advertising content detected in real time; and
deleting by said information appliance flagged commercial advertising content following the termination of the recording of multimedia programming.

2. The method of claim 1, wherein said information application comprises a set top box.

3. The method of claim 1, wherein said information appliance is configured to receive content signals formatted for broadcast on a display device from a subscription service box.

4. The method of claim 3, wherein said information appliance and said subscription service box are embodied in discrete housings.

5. The method of claim 3, wherein said information appliance and said subscription service box are embodied in a single housing.

6. The method of claim 1, wherein said information appliance is configured to transmit content signals relating to multimedia programming to a display device.

7. The method of claim 6, wherein said information appliance is configured to transmit content signals relating to multimedia programming to a television.

8. The method of claim 6, wherein said information appliance and said display device are embodied in discrete housings.

9. The method of claim 6, wherein said information appliance and said display device are embodied in a single housing.

10. The method of claim 1, additionally comprising the step of providing a wireless remote control configured to transmit wireless signals to control the recording and playback operation of the information appliance.

11. A system for removing commercials from recorded television programs, comprising:
an information appliance configured receive content signals relating to multimedia programming and transmit content signals relating to multimedia programming to an output apparatus, wherein said information appliance includes a processor, non-volatile memory and software stored on said memory containing instructions which cause the processor to perform the following steps;
record multimedia programming in content signals received;
identify commercial advertising content interspersed in the multimedia programming being recorded in real time;
flag commercial advertising content detected in real time; and
delete flagged commercial advertising content following the termination of the recording of multimedia programming.

12. The system of claim 11, wherein said information application comprises a set top box.

13. The system of claim 11, wherein said information appliance is configured to receive content signals formatted for broadcast on a display device from a subscription service box.

14. The system of claim 13, wherein said information appliance and said subscription service box are embodied in discrete housings.

15. The system of claim 13, wherein said information appliance and said subscription service box are embodied in a single housing.

16. The system of claim 11, wherein said information appliance is configured to transmit content signals relating to multimedia programming to a display device.

17. The system of claim 16, wherein said information appliance is configured to transmit content signals relating to multimedia programming to a television.

18. The system of claim 16, wherein said information appliance and said display device are embodied in discrete housings.

19. The system of claim 16, wherein said information appliance and said display device are embodied in a single housing.

20. The system of claim 11, additionally comprising a wireless remote control configured to transmit wireless signals to control the recording and playback operation of the information appliance.
